(19) United States
(12) Patent Application Publication
(10) Pub. No.: US 2006/0023660 A1
(43) Pub. Date: Feb. 2, 2006

(54) Location structure configuration training method for use in a cellular mobile communication system

(75) Inventor: Christele Lejeune, Bievres (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/190,848

(22) Filed: Jul. 28, 2005

(30) Foreign Application Priority Data
Jul. 29, 2004 (FR) 04 08 424

(51) Int. Cl. H04Q 7/00

(52) U.S. Cl. 370/328

(57) ABSTRACT

A method is disclosed for the core network of a cellular mobile communication system to learn the configuration of location structures in a radio access network of the system. The method includes the following steps: at least one core network entity receives from at least one radio access network entity that it controls at least one message relating to a transaction with a mobile terminal served by the radio access network entity, that at least one message including information including the identity of at least one location structure of which the cell in which the mobile terminal is located is a part at the time of transmission of the message, and the core network entity uses the information to learn the configuration of the attachment of that at least one location structure to the radio access network entities that it controls.

### CROSS-REFERENCE TO RELATED APPLICATIONS

This application is based on French Patent Application No. 04 08 424 filed 29 Jul. 2004, the disclosure of which is hereby incorporated by reference thereto in its entirety, and the priority of which is hereby claimed under 35 U.S.C. §119.

### BACKGROUND OF THE INVENTION

1. Field of the Invention

The present invention relates generally to mobile communication systems.

Mobile communication systems are generally covered by standards and the corresponding standards published by the corresponding standardization organizations may be consulted for more information.

2. Description of the Prior Art

The general architecture of the above kind of system is described briefly with reference to FIG. 1. A system of this kind includes a mobile communication network 1 communicating with mobile terminals 2 and with external networks (not specifically shown). The network 1 itself includes a radio access network (RAN) 3, responsible mainly for transmission and for managing radio resources at the radio interface between the network and the mobile terminals, and a core network (CN) 4 responsible mainly for routing and for managing calls.

Changes in requirements and in technology generally lead to distinguishing between different types of services, in particular circuit services and packet services, and between different types of systems, in particular second generation systems and third generation systems.

The Global System for Mobile communications (GSM) is a typical example of a second generation system. Originally, the GSM was intended to provide mainly circuit services. Packet services were introduced subsequently, by means of the General Packet Radio Service (GPRS) function.

In a system such as the GSM/GPRS, for example:

a mobile terminal is called a mobile station (MS),

the radio access network (RAN) is made up of subsystems referred to as base station subsystems (BSS) each including a base station controller (BSC) controlling one or more base transceiver stations (BTS), and

the core network (CN) includes, in particular, for a domain related to circuit switching (CS domain), 2G-MSC network elements (where 2G stands for “2nd Generation” and MSC stands for “Mobile Switching Center”), and for a domain related to packet switching (PS domain), 2G-SGSN type network elements (where 2G stands for “2nd Generation” and SGSN stands for “Serving GPRS Support Node”).

The Universal Mobile Telecommunication System (UMTS) is a typical example of a third generation system.

In a system such as the UMTS, for example:

a mobile terminal is called a user equipment (UE),

the radio access network (RAN) is called the UMTS Terrestrial Radio Access Network (UTRAN) and is made up of subsystems referred to as radio network subsystems (RNS) each including a radio network controller (RNC) controlling one or more base stations,

a base station is referred to as a Node B, and

the core network (CN) includes, in particular, for a domain related to circuit switching (CS domain), 3G-MSC type network elements (in which 3G stands for “3rd Generation” and MSC stands for “Mobile Switching Center”) and for a domain related to packet switching (PS Domain) 3G-SGSN type network elements (where 3G stands for “3rd Generation” and SGSN stands for “Serving GPRS Support Node”).

These systems generally have a cellular architecture, and, with the particular aim of managing user mobility and controlling access rights, the cells of a given network are grouped together in groups of cells that form location structures also known as location areas (LA) in the CS domain or routing areas (RA) in the PS domain.

Mobility management procedures are generally used in these systems and generally necessitate that core network server entities (for example SGSN in the PS domain) have a knowledge of the configuration of location structures (for example RA in the PS domain) in the radio access network, in particular a knowledge of the configuration of the attachment of the various location structures to the various radio access network server entities (for example RNC in a UMTS type third generation system).

The PS domain and a UMTS type third generation system are considered by way of example hereinafter.

One example of these mobility management procedures is the paging procedure whereby, if there is data to be transferred to a UE, the network first pages the routing area (RA) in which the UE is located. The UE can then inform the network of the cell in which it is located, and the transfer of data can then take place. For correct functioning of the system, paging messages must therefore be sent by the SGSN to the RNC that controls the routing area (RA) in which the UE is located. In other words, for correct operation of the system, it is necessary for the SGSN to know the configuration of the attachment of the RA to the RNC that it controls.

Other examples of such procedures correspond to mobility management procedures such as attach procedures and RA update procedures, during which access rights are checked in the core network. The SGSN will begin to implement these procedures (or to process the content of the messages received) only for UEs in an RA known to the SGSN. In other words, for correct operation of the system, the SGSN must know the configuration of the attachment of the RA to the RNC that it controls.

The configuration of the routing areas is one of the parameters that the operator can set and modify in the context of network operation and maintenance (O&M). The operator can decide to eliminate a routing area, for example, or to attach a routing area to another RNC.

In the context of such operations, routing area configuration data is generally entered twice in succession, the first time in the radio access network and the second time in the core network.

A solution of the above kind is less than the optimum, for the following reasons in particular.

A solution of the above kind is tiresome because It necessitates coordination of operations effected separately in the radio access network and in the core network.

The above kind of solution is complex to implement in the case of a core network including at the same time 2G SGN type equipments connected to BSS type radio access network equipments and 3G SGSN type equipments connected to UTRAN type radio access network equipments, because routing area management is generally different for different technologies. Furthermore, an additional source of complexity is that in the case of the same 2G/3G SGSN equipment connected both to BSS type radio access network equipments and to UTRAN type radio access network equipments, the management of routing areas is not homogeneous within the same SGSN equipment.

A particular object of the present invention is to avoid such drawbacks.

### SUMMARY OF THE INVENTION

One aspect of the present invention consists in a method for the core network of a cellular mobile communication system to learn the configuration of location structures in a radio access network of said system, said method including the following steps:

at least one core network entity receives from at least one radio access network entity that it controls at least one message relating to a transaction with a mobile terminal served by the radio access network entity, that at least one message including information including the identity of at least one location structure of which the cell in which the mobile terminal is located is a part at the time of transmission of the message, and

the core network entity uses the information to learn the configuration of the attachment of that at least one location structure to the radio access network entities that it controls.

Another aspect of the present invention consists in a core network server entity for mobile communication systems, in particular an SGSN type entity, including means for implementing the above method.

Other aspects and features of the present invention will become apparent in the light of the following description of one embodiment of the invention, which is given with reference to the appended drawings.

### BRIEF DESCRIPTION OF THE DRAWINGS

FIG. 1, already described, outlines the general architecture of a mobile communication system.

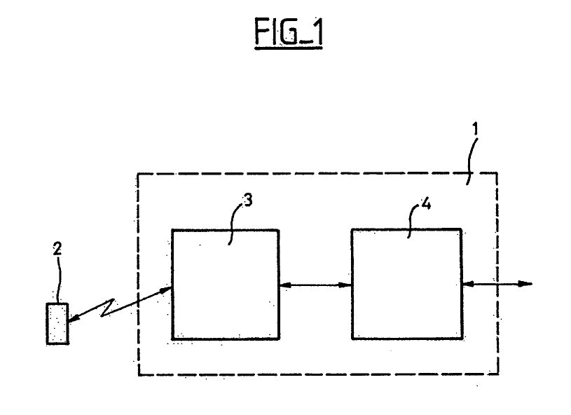

FIG. 2 shows one example of a method of the present invention.

FIG. 3 shows one example of means to be provided in a core network entity (such as an SGSN type entity in particular) to Implement a method according to the present invention.

### DETAILED DESCRIPTION OF THE PREFERRED EMBODIMENT

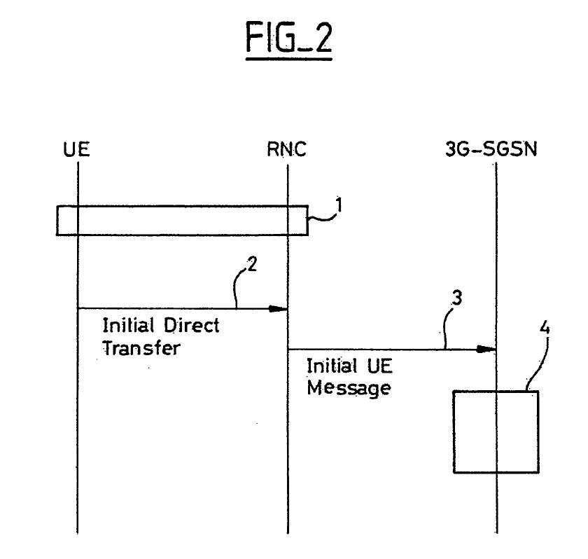

FIG. 2 shows certain exchanges of signaling used to set up a connection between a mobile terminal and a core network server entity.

The following description relates, by way of example, to the PS domain (in which case said core network server entity corresponds to an SGSN type entity) and a UMTS type third generation system (in which case the mobile terminal is denoted UE and the SGSN is denoted 3G-SGSN).

As shown by a step 1 in FIG. 2, a radio resource control (RRC) connection is set up between the mobile terminal UE and a radio access network server entity RNC, in accordance with the RRC protocol for the “Uu” interface between the UE and the UTRAN, as described in particular in the Technical Specification 3GPP TS 25.331 published by the 3rd Generation Partnership Project (3GPP).

In a step 2, using the RRC protocol, the UE sends the RNC an “Initial Direct Transfer” message in order to set up a transaction with the network, for example to implement an attach procedure, a detach procedure or an RA update procedure or for the purposes of a request for service.

The “Initial Direct Transfer” message includes in particular a “Non Access Stratum” (NAS) message that is to be transferred to the SGSN in a manner that is transparent to the RNC.

In a step 3, the RNC sends the SGSN an “Initial UE Message” in accordance with the Radio Access Network Application Part (RANAP) protocol for the “Iu” interface between the UTRAN and the CN, as described in particular in the Technical Specification 3GPP TS 25.413 published by the 3GPP. The object is to set up a signaling connection over the “Iu” interface and to transfer to the CN a data unit (NAS-PDU) corresponding to the message NAS received by the RNC over the “Uu” interface.

According to the Technical Specification 3GPP TS 25.413, the “Initial UE Message” contains other information in addition to this data unit NAS-PDU, in particular either the information LAI+RAC (Location Area Identity+Routing Area Code) corresponding to the last LAI+RAC information indicated to the UE by the UTRAN via the current RRC connection or, if the UTRAN has not yet sent information to the UE via the current RRC connection, the information LAI+RAC for the cell through which the current RRC connection has been set up. It will be remembered that in a UMTS type third generation system, certain mobility management functions are handled by the RNC, in which case the information LAI+RAC is known to the RNC, in the context of these functions.

According to the Technical Specification 3GPP TS 25.413, the information LAI+RAC is to be used by the core network for the purposes of mobility management.

The present invention proposes that the core network use this kind of information (also referred to herein as routing area identity information) to solve another problem simultaneously. The present invention proposes in particular that the SGSN use this kind of routing area identity information contained in the “Initial UE Message” received from the RNC, and likewise from other RNCs controlled by the SGSN, to acquire automatically a knowledge of the configuration of the attachment of the RAs to the RNCs controlled by that SGSN. This kind of use is indicated by a step 4 in FIG. 2.

Note that the routing area identity information is also contained in a “Direct Transfer” message sent from the RNC to the SGSN using the RANAP protocol in a step, not shown, following the step 3. However, it is possible for the “Direct Transfer” message not to be sent by the same RNC as the “Initial UE Message”. It will be remembered that for a given communication relating to a given UE, there Is an RNC, called the Serving Radio Network Controller (SRNC) having a monitoring role for the communication concerned. It should also be remembered that, during that communication, the SRNC role for that communication can be transferred from a source RNC (SRNC) to a target RNC (TRNC), for diverse reasons, such as in particular: transfer time optimization, resource allocation optimization, RNC relative load optimization, etc. This kind of transfer is effected by means of a relocation procedure. The routing area identity information contained in the “Direct Transfer” message should therefore not be used, over and above the routing area identity information contained in the “Initial UE Message”, as otherwise the RA-RNC association could be incorrect.

Accordingly, as explained above, as soon as a mobile terminal UE attempts to communicate with an SGSN, to set up a transaction with the network, the RNC sends a “Initial UE Message” to the SGSN.

The invention therefore proposes that the SGSN use the routing area identity information contained in the messages received in this way from that RNC, and likewise from other RNCs that it controls, to acquire automatically a knowledge of the configuration of the attachment of the RAs to the RNCs controlled by that SGSN.

The configuration data acquired in this way can be stored in a routing area configuration database, in particular in the form of an RA-RNC association.

If a routing area is subsequently deleted in the context of O&M operations for the radio access network, or is moved from one RNC to another, the SGSN should make the corresponding change in the routing area configuration database of the SGSN.

However the protocols for communication over the UTRAN-CN interface, also known as the “Iu” interface, provide no message or information that would enable the SGSN to remove a routing area from that database automatically, on the basis of information coming directly from the UTRAN.

The present invention also proposes a solution to this problem. The present invention proposes that as soon as the SGSN detects that no traffic is stored in a routing area, for example at the end of a particular time period (for example at the end of a time-delay), that the routing area concerned be deleted from that database. For example, the SGSN detects that no traffic is stored in a given RA if it receives no “Initial UE Message” from a connected RNC relating to a UE situated in that RA during a given time period, which is advantageously configurable by means of O&M operations.

One aspect of the present invention is a method for the core network of a cellular mobile communication system to learn the configuration of location structures in a radio access network of the system, the method including the following steps:

at least one core network entity receives from at least one radio access network entity that it controls at least one message relating to a transaction with a mobile terminal served by the radio access network entity, that at least one message including information including the identity of at least one location structure of which the cell in which the mobile terminal is located is a part at the time of transmission of the message, and

the core network entity uses the information to learn the configuration of the attachment of that at least one location structure to the radio access network entities that it controls.

In particular, in the example described above, that at least one location structure may be a routing area.

In particular, in the example described above, the message is a message transmitted to set up a transaction between a mobile station and a network.

In particular, in the example described above, the message is an “Initial UE Message” transmitted in accordance with the Radio Access Network Application Part Protocol in a UMTS type third generation system.

Another aspect of the present invention is a core network entity, in particular an SGSN type entity, including means for implementing the above method.

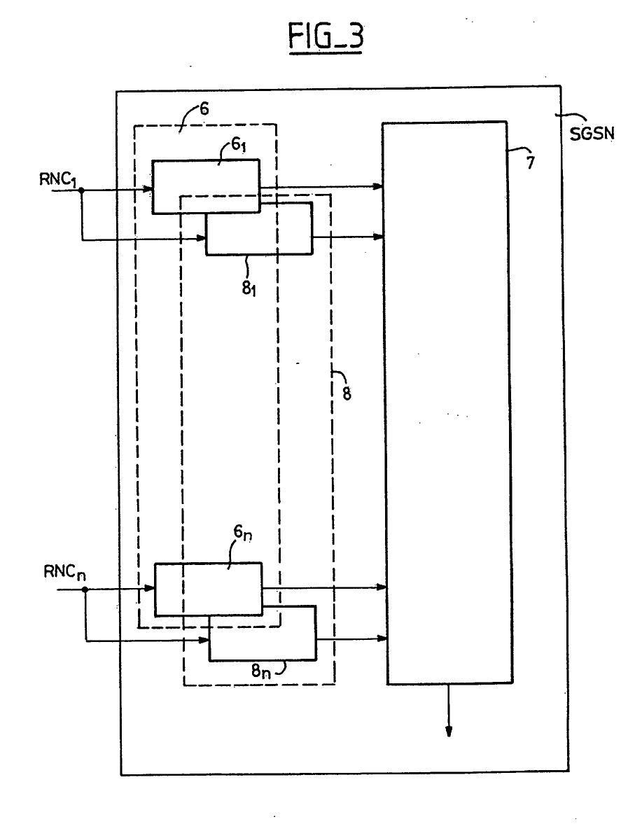

As shown in FIG. 3, a core network entity (such as an SGSN entity) may therefore comprise, in addition to other means not referred to here because they do not form part of the invention:

means referred to as first means for receiving from at least one radio access network entity (e.g. at least one RNC) that it controls at least one message relating to a transaction with a mobile terminal served by the radio access network entity, the message including information including the identity of at least one location structure of which the cell in which the mobile terminal is located is a part at the time of transmission of the message,

means referred to as second means for using the information to learn the configuration of the attachment of the at least one location structure to the radio access network entities that it controls.

In the example shown in FIG. 3, the first and second means are denoted 6. In the example shown in FIG. 3, in which an SGSN controls “n” RNCs denoted RNC₁ to RNCₙ, the means 6 include means denoted 6₁ to 6ₙ for respectively determining, from routing area identity information received from the respective RNCs RNC₁ to RNCₙ, the RAs that are attached to them and for supplying corresponding configuration data.

The SGSN advantageously further includes means referred to as third means for storing configuration data acquired in this way, those means being denoted 7 and being also referred to as a configuration database.

The SGSN advantageous further includes means referred to as fourth means for deleting stored configuration data from the database 7 if no traffic is stored in a location structure, in particular at the end of a particular time.

In the example shown in FIG. 3, the fourth means are denoted 8. In the example shown in FIG. 3, in which an SGSN controls “n” RNCs denoted RNC₁ to RNCₙ, the means 8 include means denoted 8₁ to 8ₙ for respectively detecting, on the basis of traffic information received from the respective RNCs RNC₁ to RNCₙ, if no traffic is stored in a given RA, in which case that routing area may be deleted from that database.

The configuration data stored in this way in the database 7 may be used in particular for the purposes explained in the introduction. The means for using it are not specifically shown in FIG. 3, however.

The various means described may operate in accordance with the method described above; their particular implementation representing no particular difficulty for the person skilled in the art, such means need not be described here in more detail than by stating their function.

There is claimed:

1. A method for the core network of a cellular mobile communication system to learn the configuration of location structures in a radio access network of said system, said method including the following steps:
at least one core network entity receives from at least one radio access network entity that it controls at least one message relating to a transaction with a mobile terminal served by said radio access network entity, said at least one message including information including the identity of at least one location structure of which the cell in which said mobile terminal is located is a part at the time of transmission of said message, and
said core network entity uses said information to learn the configuration of the attachment of said at least one location structure to the radio access network entities that it controls.

2. The method claimed in claim 1, wherein said at least one location structure is a routing area.

3. The method claimed in claim 1, wherein said message is a message transmitted to set up a transaction between a mobile station and a network.

4. The method claimed in claim 1, wherein said message is an “Initial UE Message” transmitted in accordance with the Radio Access Network Application Part Protocol in a UMTS type third generation system.

5. A mobile communication network core network entity comprising:
means for receiving from at least one radio access network entity that it controls at least one message relating to a transaction with a mobile terminal served by said radio access network entity, said message including information including the identity of at least one location structure of which the cell in which said mobile terminal is located is a part at the time of transmission of said message,
means for using said information to learn the configuration of the attachment of said at least one location structure to the radio access network entities that it controls.

6. The entity claimed in claim 5, further comprising means for storing configuration data acquired in this way.

7. The entity claimed in claim 5, further comprising means for deleting stored configuration data if no traffic is stored in a location structure, in particular at the end of a particular time.
